(19) United States
(12) Patent Application Publication
(10) Pub. No.: US 2021/0232433 A1
(43) Pub. Date: Jul. 29, 2021

(54) OPERATIONS COST AWARE RESOURCE ALLOCATION OPTIMIZATION SYSTEMS AND METHODS

(71) Applicant: Kohl's, Inc., Menomonee Falls, WI (US)

(72) Inventors: Yepeng Sun, Fremont, CA (US); Alan Lee, Sunnyvale, CA (US)

(21) Appl. No.: 17/160,244

(22) Filed: Jan. 27, 2021

Related U.S. Application Data
(60) Provisional application No. 62/966,913, filed on Jan. 28, 2020.

(51) Int. Cl. G06F 9/50; G06F 11/34; G06F 17/18

(52) U.S. Cl. CPC G06F 9/5027; G06F 17/18; G06F 11/3433

(57) ABSTRACT

Optimization systems and methods to generate optimized resource allocations are disclosed. To generate an optimized resource allocation, a system or method accesses a relationship model defining a statistical relationship between operations data values and performance data values. The relationship model also includes a confidence score indicating a degree of confidence in the statistical relationship between the operations data values and the performance data values for each of a plurality of the operations data values. Using the relationship model, an operations value is selected to achieve an optimal value of the performance data values. The selected operations value is selected from a set of operations data values for which the corresponding confidence score exceeds a specified threshold, and the optimal value of the performance data represents an optimum of the performance data values that are mapped, by the relationship model, to the operations data values in the set.

### CROSS-REFERENCE TO RELATED APPLICATION

This application claims the benefit of U.S. Provisional Patent App. No. 62/966,913, filed Jan. 28, 2020, which is incorporated herein by reference in its entirety.

### BACKGROUND

Many types of businesses adjust parameters associated with their operations in order to achieve performance targets. For example, a retail store may adjust operations parameters to achieve performance targets, such as revenue, foot traffic, transaction volume, or transaction amount. These operations parameters may include the number of employees working in the store at a given time, the types of employees working in the store at a given time, the number of labor hours by the employees over a specified time period, or the store's operating hours.

To predict a value of the operations parameter that will achieve a particular performance metric at a given time, some businesses use models that relate historical operations parameters to corresponding measured performance values. However, existing models do not take into account varying levels of risk associated with different values of the operations parameters. For example, increasing the number of employees working in a retail store at a given time may have increasing levels of risk as the number of employees increases. This is because the amount of performance data available for extraordinarily high numbers of employees (e.g., during peak holiday hours) may be significantly lower than the amount of data available for other values of the operations parameter. As the number of employees working at a given time increases, the cost to pay the employees increases with each added employee, but the performance of the store may not increase with the added employees or may not increase as much as the cost of the labor hours. This reality may not be adequately represented in the model in a manner that accurately conveys the risk associated with the increased employee numbers. Furthermore, existing models are often impractical for large enterprises with many business locations, where resources can be shared between locations but where each location has its own unique risk profile that makes it difficult to evaluate how best to divide the resources between the locations.

### BRIEF DESCRIPTION OF THE DRAWINGS

FIG. 1 is a system diagram illustrating an example of a computing environment in which the optimization system operates in some implementations.

FIG. 2 is a block diagram illustrating the operation of the optimization system of FIG. 1.

FIG. 3 is a block diagram showing some of the components typically incorporated in at least some of the computer systems and other devices on which the optimization system operates.

FIG. 4 is a process diagram illustrating operation of the optimization system of FIG. 1.

FIG. 5 is a data flow diagram illustrating operation of the optimization system of FIG. 1.

FIG. 6A is a chart illustrating a graphical view of performance data, operations data, and a relationship model.

FIG. 6B is a table illustrating a tabular view of a relationship model.

FIG. 7A is a chart illustrating two segmented (e.g., tabularized, aggregated) relationship models.

FIG. 7B is a chart illustrating confidence scores corresponding to the relationship models illustrated in FIG. 7A.

FIG. 8A is a table illustrating operations constraints utilized by the optimization system of FIG. 1.

FIG. 8B is a table illustrating optimized resource allocations generated by the optimization system of FIG. 1.

FIG. 9 is a process diagram illustrating a method for generating optimized resource allocations.

### DETAILED DESCRIPTION

### Introduction

The present disclosure is directed to systems and methods to generate optimized resource allocations while accounting for dynamic relationships between operations costs and performance. To overcome the disadvantages of conventional systems, an optimization system and method generate an optimized resource allocation based on relationship models (e.g., models that represent relationships between employee work hours and sales revenue) and constraints (e.g., dynamic constraints). A relationship model facilitates the projection of a performance metric for a particular value of an operations parameter. In an example implementation, a relationship model defines the relationship between employee work hours and sales revenue in a retail store. The optimization engine is configured to determine one or more values of the operations parameter that optimizes (e.g., minimizes, maximizes, etc.) the selected performance metric. The optimization engine accounts for constraints on the operations parameter and/or performance metric, and can further calculate dynamic constraints. For example, the cost of increasing staffing can offset potential increased sales. This complex relationship is difficult to analyze using existing systems.

Further, the optimization system organizes data from multiple organizational units (e.g., sales from individual stores, staffing in individual departments, etc.), and is configurable to generate individually optimized values of the operations parameter for each unit. For example, sales and staffing data from a chain of stores can be utilized by the optimization engine to determine optimal staffing levels customized for each location.

In some implementations, a method for optimizing resource allocations in a retail store includes retrieving a relationship model that defines a statistical relationship between operations data and performance data and that includes confidence scores indicating degrees of confidence in the statistical relationship. Tabular data is extracted from the relationship model, where tabular data points in the tabular data represent a value of the performance parameter and a confidence score that are each sampled from the relationship model for each of a plurality of segments of the operations data. The tabular data is analyzed to select an operations value of the operations data to achieve an optimal value of the performance data. The operations value is selected from a set of values of the operations data for which the corresponding confidence score exceeds a confidence score threshold, and the optimal value of the performance data represents an optimum of the values of the performance data that are mapped, by the relationship model, to the set of values of the operations data. The selected operations value is stored, for example for use in a retail store.

In some implementations, a non-transitory computer readable storage medium stores executable computer program instructions that, when executed by a processor, cause the processor to retrieve a first relationship model associated with a first retail store and a second relationship model associated with a second retail store, where the first and second retail stores share a pool of available resources (e.g., a number of employees available to work at the first retail store and the second retail store, or a total labor hours budget for the first retail store and the second retail store). Each of the first and second relationship models define a statistical relationship between operations data and performance data measured in the respective retail store. For each of the first relationship model and second relationship model, the processor analyzes a performance measurement derived from the corresponding relationship model for each of a plurality of intervals of the operations data. A constraint associated with the pool of available resources is applied to the performance measurements to allocate the pool of available resources between the first retail store and the second retail store, where the allocation is selected to satisfy the constraint and achieve a collective performance target for the first retail store and the second retail store. The selected allocation is stored.

Some implementations of a system for optimizing resources in a retail store include a processor and a non-transitory computer readable medium that stores computer program instructions executable by the processor. When executed, the instructions cause the processor to access a relationship model that defines a statistical relationship between operations data values and performance data values measured in a retail store and that includes a confidence score indicating a degree of confidence in the statistical relationship between the operations data values and the performance data values for each of a plurality of the operations data values. Using the relationship model, the processor selects an operations value of the operations data values to achieve an optimal value of the performance data values. The selected operations value is selected from a set of operations data values for which the corresponding confidence score exceeds a specified threshold, and the optimal value of the performance data represents an optimum of the performance data values that are mapped, by the relationship model, to the operations data values in the set. The selected value of the operations data is implemented in the retail store.

Embodiments of an optimization system is described, including a computing device and a database system. The optimization system is configured to retrieve performance and operations data from multiple locations, such as retail store locations, franchise locations, business offices, and the like. More specifically, the performance and operations data can be retrieved from point of sale systems, employee management systems, accounting databases, ecommerce analytics systems, and the like. In some implementations, performance data comprises sales revenue, and operations data comprises employee timesheet data (e.g., number of hours worked).

The optimization system is configured to calculate performance metrics values from the performance data, and operations parameter(s) values from the operations data. In some implementations, the optimization system can automatically select one or more performance metrics and operations parameters. In some implementations, the operations parameter(s) and/or the performance metric(s) can be user-configurable through, for example, a web interface. In an example implementation, the performance metric includes sales revenue per period, and the operations parameter includes the total employee work hours per period. Periods may include calendar weeks, individual days, quarters, months, rolling time periods, etc. The optimization system can be configured to aggregate the performance and/or operations data to calculate values of the performance metric and/or operations parameter. Generally, the operations parameter includes a controllable independent variable, and the performance metric includes a dependent variable to be optimized. For example, in a retail store, the operations parameter includes employee timesheet data, employee schedule data, mobile device location data, employee assignment data, or retail store operating hours. The performance data for the retail store includes, for example, payment transaction data, revenue data, profit data, interaction conversion data, transaction volume data, transaction amount data, or physical traffic data.

In the example implementation, the optimization system is configured to generate a relationship model. In other implementations, the optimization retrieves/requests a relationship model. The relationship model facilitates the projection of a performance metric (e.g., sales revenue for a time period) for one or more values of an operations parameter. In some implementations, the relationship model can be a plot diagram (e.g., a partial dependency plot) illustrating projected performance metric values for a range of values of an operation parameter. The relationship model can be described as modeling the relationship between a set of operations parameters and a set of performance metrics. In this manner, the relationship models enables forecasting of the performance of certain operations decisions.

In an example implementation, the relationship model defines the relationship between employee work hours and sales revenue. For example, the relationship model can be used to investigate the impact of staffing decisions. The relationship model can predict increased sales in response to increased staffing, up to a certain point, after which the gains may be reduced (e.g., diminished sales, low predicted increases in sales). The relationship model enables a mathematical/statistical approach to controlling operations parameters, such as the staffing of a location (e.g., the total number of hours worked by employees).

The optimization system accounts for the risk associated with increased operations parameters. In one example, increasing staffing (i.e., an operations parameter) can have a significant upfront financial cost. The optimization system is configured to interrogate a generated relationship model to determine confidence scores. In some implementations, the confidence level is calculated using subsampling. The optimization system leverages the confidence scores in the process of determining an optimized resource allocation.

The optimization system can optimize the operations parameter in view of user-configurable constraints and a risk parameter. Stored constraints include constraints on the operations parameter and/or performance metric, such as minimum/maximum values. In some implementations, stored constraints include dynamic constraints that define an additional relationship between the performance metric and the operations parameter. For example, stored constraints can include a cost per labor hour, which impacts optimizations directed to net profit. Stored constraints may also include budgets for a planning period, and budgets may be defined at a chain level, for multiple locations, or a single location. For example, the cost of labor hours at multiple locations may be aggregated and compared to a regional budget constraint.

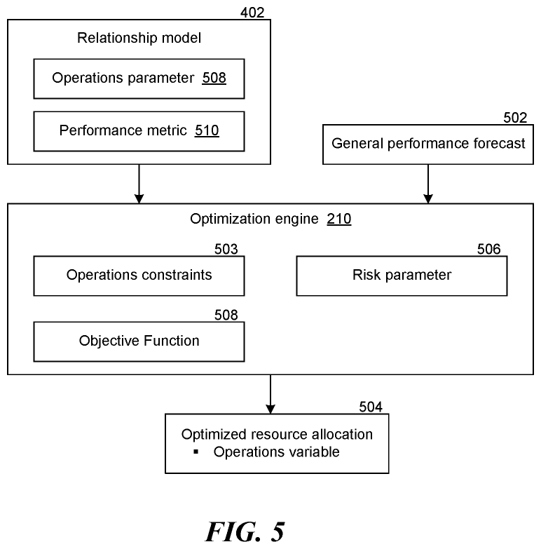

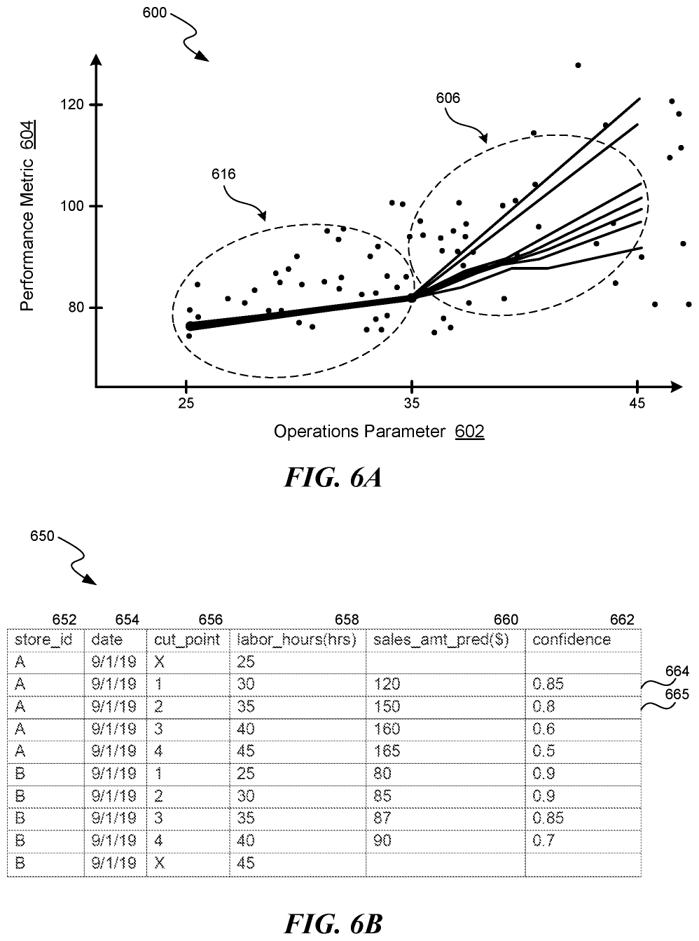

The optimization system generates an optimized resource allocation. More specifically, the optimization system analyzes the relationship model and the constraints retrieved. The optimization system then determines an optimized resource allocation (e.g., a value of the operations parameter) that optimizes (e.g., minimizes, maximizes) the performance metric while considering the constraints (e.g., cost of labor, maximum/minimum values). The generation of optimized resource allocations is further described in relation to FIG. 5, and is illustrated in FIGS. 6-8.

System Overview

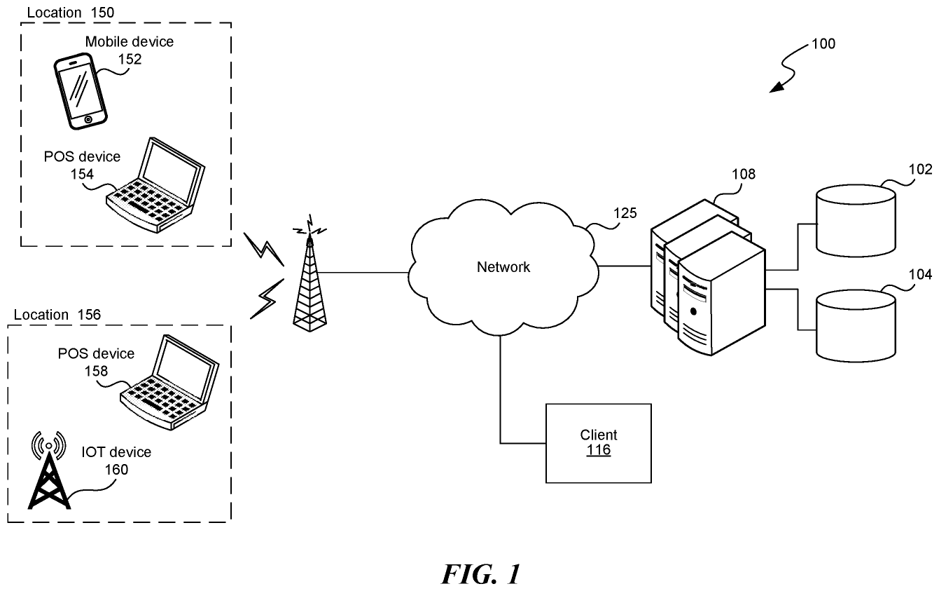

FIG. 1 is a system diagram illustrating an example of a computing environment in which the optimization system operates in some implementations. Optimization system 100 comprises computing device(s) 108, and any number of client devices. In the illustrated implementation, optimization system 100 comprises mobile device 152, POS device 154, POS device 158, internet of things (IOT) device 160, and client device 116.

Computing device 108 is configured to retrieve performance and operations data from multiple locations, using network 125. Network 125 can be a local area network (LAN) or a wide area network (WAN), but can also be other wired or wireless networks. In some implementations, network 125 is the Internet or some other public or private network. Client computing devices (e.g., mobile device 152, POS device 154 and/or 158, IoT device 160, etc.) are connected to network 125 through a network interface, such as by wired or wireless communication. The connection between computing device 108 and network 125 can be any kind of local, wide area, wired, or wireless network.

Computing device 108 can retrieve performance data from multiple locations and/or data sources, using network 125. Examples of performance data include, but are not limited to, revenue, conversions, profits, transaction volume, and average transaction amount. Performance data 102 can further include activity and engagement metrics. For example, performance data 102 can include the number of people that entered a location, or the number of people that interacted with an employee. Performance data 102 can be grouped/segmented based on time periods (e.g., daily, hourly, weekly, quarterly, monthly). Performance data 102 can also include ‘internet-of-things’ data, such as data from motion-sending lighting systems, air systems, and the like.

In an example implementation, computing device 108 retrieves performance data from point of sale (“POS”) device 154 at location 150. For example, POS device 154 can generate payment transactions, and computing device 108 can be configured to retrieve aggregate revenue data from POS device 154. Computing device 108 can be configured to track/store the location associated with retrieved performance data 102. Computing device 108 can retrieve performance data (and associated location data) from POS device 154 at location 150, and from POS device 158 at location 156. The location data can be in the form of coordinates (e.g., latitude and longitude), address, location identifier, contact number, other identifying information, and so on.

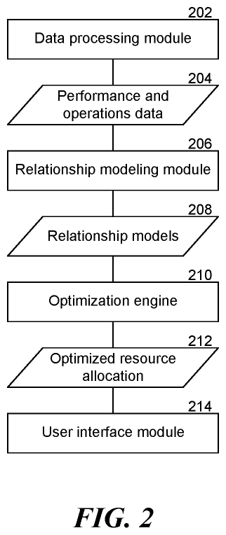

In an example implementation, performance data 102 includes aggregate revenue. Performance data 102 can also include any performance metric, such as aggregate profit, consumer transaction volume, and the like, as described in relation to FIG. 2. Computing device 108 can retrieve performance data from POS devices, and/or any other system storing performance data. In some implementations, computing device 108 can retrieve performance data (e.g., customer conversions, number of pages visited, and so on) from an ecommerce analytics computing device. In yet another implementation, computing device 108 can retrieve performance data (e.g., billable hours, sales volume, and so on) from databases such as accounting databases, customer relationship management (CRM) systems, sale order databases, and the like. The structure and processing of performance data 102 is further described in relation to FIG. 2.

Computing device 108 can retrieve operations data 104 from multiple locations and/or data sources, using network 125. Examples of operations data include, but are not limited to, labor hours, operation hours, staffing headcount, and the like. For example, operations data 104 can include daily labor hours (e.g., total hours worked across employees) for a set of days. As another example, operations data 104 can include, for a set of days, the number of employees that worked on each day. Operations data 104, generally, represents a controllable parameter (e.g., an independent variable) associated with a cost or limited resource, and potentially with performance data (e.g., a dependent variable).

In an example implementation, computing device 108 retrieves operations data 104 from mobile device 152 at location 150 and internet of things (IOT) device 160 at location 156. For example, computing device 108 can retrieve employee schedules/timesheets from mobile device 152. As another example, energy usage data can be retrieved from IOT device 160. Operations and/or performance data 102 can be generated by IOT devices. For example, IOT devices can be used to generate operations data, such as number of workers at a particular store location, busyness of workers, cleanliness of store locations, merchandize stock, and so on.

In the illustrated implementation, computing device 108 retrieves operations data 104 from mobile device 152. Mobile device 152 can be an app-focused mobile device, such as a smartphone or tablet. In one example, mobile device 152 includes a worker scheduling application, storing worker schedules and timesheets. Operations data 104 includes labor hours, worker schedules, and worker timesheets. In some implementations, mobile device 152 can include a workload management application, tracking the tasks (e.g., cleaning tasks, stocking tasks) and assignments (e.g., greeter, cashier) associated with a worker. Operations data 104 includes tasks completed by a worker, time spent by a worker on certain tasks, time spent on certain assignments. In some implementations, operations data 104 can include sensor data generated by mobile device 152. For example, operations data 104 can include location data associated with mobile device 152. More specifically, operations data 104 can include, for a specific time, the number of mobile devices within a location, and the position of the mobile devices within the location. Thus, the utilization and workflow of the mobile devices (e.g., mobile device 152) can be represented in operations data 104. The structure and processing of operations data 104 is further described in relation to FIG. 2.

Computing device 108 can be an edge server which receives client requests and coordinates fulfillment of those requests through other servers. Computing device 108 can be a distributed computing environment encompassing multiple computing devices located at the same or at geographically disparate physical locations. In some implementations, computing device 108 corresponds to a group of servers. In other implementations, computing device 108 can correspond to a single server.

Computing device 108 is configured to store operations data 104 and performance data 102. In FIG. 1, operations data 104 and performance data 104 are illustrated symbolically. In example implementations, operations data 104 and performance data 102 can be stored in a database system. In other implementations, operations data 104 and performance data 102 can be stored in remote data storage systems, such as e-commerce systems, point-of-sale systems, and so on. In some implementations, performance data 102 and operations data 104 can share an underlying database or can have its own database. Though performance data 102 and operations data 104 are displayed logically as single units, any database system can be implemented by computing device 108 to store this data. The database system can be a distributed computing environment encompassing multiple computing devices, can be located with computing device 108, or can be located at a geographically disparate physical location.

FIG. 1 and the discussion herein provide a brief, general description of a suitable computing environment in which the optimization system 100 can be supported and implemented. Although not required, aspects of the optimization system 100 are described in the general context of computer-executable instructions, such as routines executed by a computer, e.g., mobile device, a server computer, or personal computer. The system can be practiced with other communications, data processing, or computer system configurations, including: Internet appliances, hand-held devices (including tablet computers and/or personal digital assistants (PDAs)), Internet of Things (IoT) devices, all manner of cellular or mobile phones, multi-processor systems, microprocessor-based or programmable consumer electronics, set-top boxes, network PCs, mini-computers, mainframe computers, and the like. Indeed, the terms “computer,” “host,” and “host computer,” and “mobile device” and “handset” are generally used interchangeably herein, and refer to any of the above devices and systems, as well as any data processor.

Aspects of the system can be embodied in a special purpose computing device or data processor that is specifically programmed, configured, or constructed to perform one or more of the computer-executable instructions explained in detail herein. Aspects of the system can also be practiced in distributed computing environments where tasks or modules are performed by remote processing devices, which are linked through any communications network, such as a Local Area Network (LAN), Wide Area Network (WAN), or the Internet. In a distributed computing environment, program modules can be located in both local and remote memory storage devices.

Aspects of the system can be stored or distributed on computer-readable media (e.g., physical and/or tangible non-transitory computer-readable storage media), including magnetically or optically readable computer discs, hard-wired or preprogrammed chips (e.g., EEPROM semiconductor chips), nanotechnology memory, or other data storage media. Indeed, computer implemented instructions, data structures, screen displays, and other data under aspects of the system can be distributed over the Internet or over other networks (including wireless networks), on a propagated signal on a propagation medium (e.g., an electromagnetic wave(s), a sound wave, etc.) over a period of time, or they can be provided on any analog or digital network (packet switched, circuit switched, or other scheme). Portions of the system reside on a server computer, while corresponding portions reside on a client computer such as a mobile or portable device, and thus, while certain hardware platforms are described herein, aspects of the system are equally applicable to nodes on a network. In an alternative implementation, the mobile device or portable device can represent the server portion, while the server can represent the client portion.

FIG. 2 is a block diagram illustrating the operation of the optimization system 100 of FIG. 1. Optimization system 100 generates resource allocations to optimize (e.g., minimize, maximize) performance metrics. For example, optimization system 100 can determine an optimal level of advertising dollars spent to maximize foot traffic to a retail store without unnecessary spending. As another example, optimization system 100 can determine a staffing level (e.g., number of employees, labor hours) that maximizes sales. As yet another example, optimization system 100 can determine a staffing level that minimizes the number of idle checkout employees. Optimization system 100 is configured to retrieve performance and operations data from a variety of data sources to construct the optimized resource allocation.

Optimization system 100 includes data processing module 202. Data processing module 202 is configured to retrieve performance and operations data 204. Data processing module 202 can communicate with database systems, disk storage systems, data source APIs, and so on. For example, data processing module 202 can communicate with data storage systems to retrieve performance data 102 and operations data 104, illustrated in FIG. 1, by, e.g., retrieving records from one or more tables in a database system. As another example, data processing module 202 can be configured to retrieve data from an enterprise resource planning (ERP) system using an API (e.g., a web-request based application programming interface). As yet another example, data processing module 202 can be configured to retrieve sales data from point-of-sale devices, which can include mobile devices.

Relationship modeling module 206 is configured to generate relationship model 208 based on performance and operations data 204. More specifically, relationship modeling module 206 analyzes the relationship between operations parameters (e.g., labor hours worked, advertising spending) and performance metrics (e.g., revenue, customer volume). For example, relationship model 208 can indicate that increased labor hours cause an increase in sales, up to a point. Relationship model 208 can also be visualized as a curve defining a computed relationship between an operations parameter and a performance metric. For example, the curve may illustrate a positive correlation between labor hours and sales. Relationship model 208 implements computational methods (e.g., regression analysis algorithms) to generate relationship model 208 based on stored performance and operations data 204. In an example implementation, relationship model 208 relates labor hours worked per month to forecasted total sales per month.

Optimization engine 210 analyzes relationship model 208 to select optimized resource allocation 212. In other words, optimization engine 210 analyzes the projected relationship between operations parameters and performance metrics to select an optimized value of the operations parameter. Optimization engine 210 stores rules and constraints to inform the determination of optimized resource allocation 212. Constraints can include a minimum/maximum value of an operations parameter, defined for example as a minimum number of employees needed to operate an open retail store or a maximum number of employees of the store or that can work in the store at the same time. In some implementations, constraints include dynamic constraints applied to the values of the performance data or the relationship between the operations data and the performance data, such as a cost per labor hour, cost of advertising spending, cost (e.g., utilities) of increased operating hours, and so on. Optimization engine 210 can be configured to consider dynamic constraints (e.g., the rising cost of labor) when computing optimized resource allocation 212. In one implementation, dynamic constraints include budget constraints defined for an organizational unit (e.g., enterprise level, chain level, department level, region level, geographic area, etc.). For example, optimization engine 210 may optimize operations parameters for multiple locations in a region, while also complying with a budget constraint defined at the region level. In the example implementation, optimization engine 210 can select a value for labor hours worked per period (e.g., month) that optimizes for total sales per period, while staying within the constraints.

In some implementations, optimization engine 210 is configured to group performance and operations data 204 before generating optimized resource allocation 212. For example, optimization engine 210 can generate a unique optimized resource allocation for each store in a chain. Optimization engine 210 can group performance and operations data 204 based on any column/field. In some implementations, performance and operations data 204 can be grouped based on store, department, division, line of business, practice group, office location, employee title, job role, season, store type, and so on. Overall, optimization engine 210 can consider performance and operations data 204 on a holistic level, before generating multiple specialized optimized resource allocations for individual units such as store locations and/or departments. In one implementation, relationship models are trained on data at a specific aggregated chain level (e.g., from multiple locations, departments, and/or units). Optimization engine 210 can leverage chain-level data to generate resource allocations that are specific to individual store locations, but with the benefit of high level trend analysis from the whole chain-wide data set. The generation of multiple optimized resource allocations is further described in relation to FIGS. 5, 6A, and 6B.

Optimization system 100 includes user interface module 214, which is configured to display/visualize optimized resource allocation 212. For example, user interface module 214 can generate a webpage including a chart visualization based on both relationship model 208 and optimized resource allocation 212. For example, user interface module 214 can generate an interactive chart including a curve representing relationship model 208, with optimized resource allocation 212 annotated on the curve.

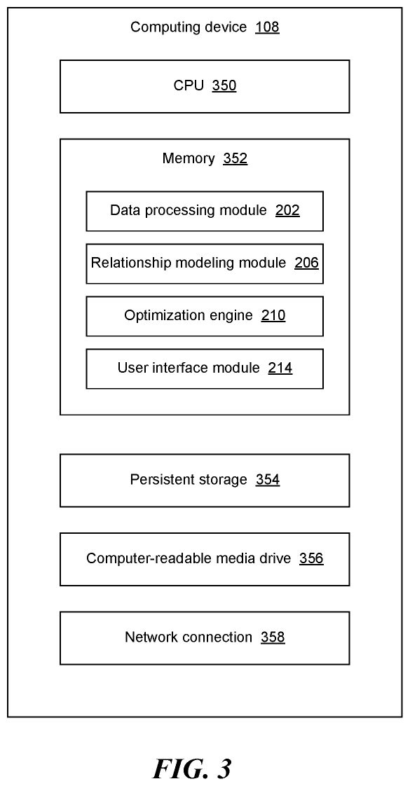

FIG. 3 is a block diagram showing some of the components typically incorporated in at least some of the computer systems and other devices on which the optimization system operates. In various implementations, these computer systems and other devices can include server computer systems, desktop computer systems, laptop computer systems, mobile computing devices, smartphones, tablets, etc. In various implementations, the computer systems and devices include zero or more of each of the following: at least one processor (e.g., central processing unit (“CPU”)) 350 for executing computer programs; at least one computer memory 352 for storing programs, data, and/or executable instructions while they are being used, including the recommendation system and associated data, an operating system including a kernel, and device drivers; at least one persistent storage device 354, such as a hard drive or flash drive for persistently storing programs and data; at least one computer-readable media drive 356 that is tangible storage means that do not include a transitory, propagating signal, such as a floppy, CD-ROM, or DVD drive, for reading programs and data stored on a computer-readable medium; and at least one network connection 358 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the optimization system, those skilled in the art will appreciate that the optimization system can be implemented using devices of various types and configurations, and having various components.

Computing device 108 implements a number of software modules, stored in memory 352, to facilitate the operation of the optimization system. In an example implementation, computing device 108 implements data processing module 202, relationship modeling module 206, optimization engine 210, and user interface module 214. These modules are stored in memory 352. In some implementations, these modules can be distributed across multiple computing devices, such as in a distributed computing system. Additionally or alternatively, these modules can be stored in persistent storage 354, or on network-accessible storage.

Data processing module 202 is configured to store/retrieve operations data and/or performance data. Database module 202 can interact with one or more database systems, such as local database systems, local mass storage, remote database systems, cloud database systems, distributed database systems, and the like. Database module 202 is configured to generate and execute database queries to retrieve and/or modify performance data 102 and operations data 104 (shown in FIG. 1). Performance data 102 and operations data 104 can be stored as relational database records, key-value records, object-oriented data records, document-oriented data records, etc.

Data processing module 202 is configured to filter, aggregate, group, and/or otherwise transform performance data 102 and/or operations data 104. For example, data processing module 202 can be configured to group sales data by store location, aggregate sales data by timeframe (e.g., calendar week, month, day). Further, data processing module 202 can be configured to aggregate employee operations data (e.g., timesheets, schedules) to calculate the total worked hours for a timeframe. Data processing module 202 can also be configured to filter/aggregate data based on an associated location, such as a retail location or business office.

Interface module 214 implements a user interface and/or application programming interface (API). In some implementations, interface module 214 is a web application server, configured to provide a web application to client computing devices. The web application can be configured to facilitate the selection of operations parameters and performance metrics and can interact with visualization module 214 to display optimized resource allocations. In other implementations, interface module 214 provides an API to client computing devices. Client computing devices can request optimized resource allocations using the API. The API can include a HTTP-based API.

In some implementations, relationship modeling module 206 generates relationship models. The relationship model can be visualized as a curve relating an operations parameter to a performance metric. The relationship model forecasts projected levels of the performance metric for a range of values of the operations parameter. Relationship modeling module 206 selects an operations parameter (e.g., an independent variable) from the operations data. For example, relationship modeling module 206 can select employee labor hours as the performance parameter, based on operations data including time/attendance data, timesheet data, staffing schedule data, etc. As another example, relationship modeling module 206 can select an operation parameter of advertising dollars spent from an invoice database including advertising invoices (e.g., operations data). Relationship modeling module 206 further selects at least one performance metric from the performance data. For example, relationship modeling module 206 selects a performance metric of total sales from a transaction database (e.g., performance data), and/or a business intelligence system. In one implementation, relationship modeling module 206 communicates with a cloud-based relationship modeling system and/or a 3rd-party software library for relationship modeling. In other implementations, relationship modeling module 206 locally generates a relationship model.

The operation of optimization engine 210 is further described in relation to FIG. 5. Overall, optimization engine selects a value for an operations parameter that optimizes (e.g., minimizes, maximizes) a performance metric, while accommodating multiple constraints.

### Optimization Engine

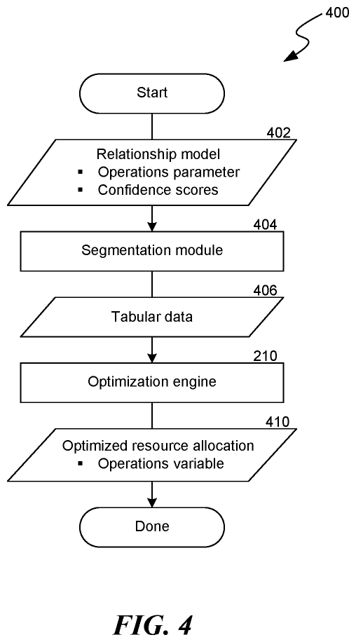

FIG. 4 is a process diagram illustrating operations 400 of the optimization system 100 of FIG. 1, including illustrating pre-processing of relationship models before they are optimized by an optimization engine 210. Optimization system 100 includes segmentation module 404, which is configured to tabularize (e.g., split into segments and aggregate) the continuous (e.g., defined by a continuous curve) mathematical models included in relationship model 402. In other words, segmentation module 404 is configured to translate statistical/mathematical models into data suitable for computational optimization.

More specifically, relationship model 402 defines a relationship (e.g., curve, statistical projection) between an operations parameter (e.g., advertising spend, labor hours) and a performance metric (e.g., transaction volume, revenue). In some implementations, relationship model 402 includes multiple operations parameters and/or multiple performance metrics.

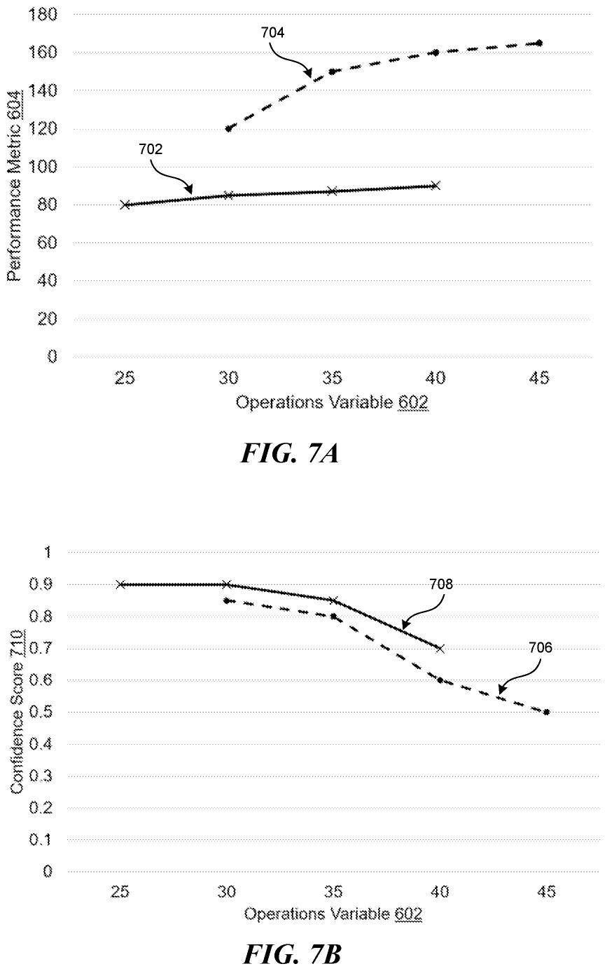

Notably, relationship model 402 further includes confidence scores. The confidence scores define a statistical confidence (e.g., a degree of uncertainty/unpredictability) in the computed relationship. These confidence scores can be visualized as a supplemental curve to the curve of the associated relationship model, as illustrated in FIGS. 7A and 7B. As a simplified example, a relationship model can be determined for data with a high standard deviation, but the relationship model can have low confidence scores. Overall, a relationship model can have multiple confidence scores. In other words, relationship model 402 can accept input of an operations parameter, and return a performance metric projection in addition to a confidence score for that specific performance projection.

In some implementations, the confidence scores in the relationship model 402 are calculated by generating subsamples of the performance data corresponding to each of a plurality of intervals of the operations data. For each subsample, a regression is performed to calculate an intermediate relationship model that defines a relationship between the subsample and the interval of operations data. The regressions for each subsample can then be compared to generate a confidence score for the interval. In various implementations, the confidence score for an interval is determined, for example, by calculating a ratio between values of two or more of the intermediate models within the interval, or by calculating a ratio or difference between slopes of the curves of the intermediate models within the interval

Segmentation module 404 is configured to aggregate/process performance relationship model 402 into tabular data 406. In other words, segmentation module 404 defines different levels (e.g., ranges, intervals) of the operations parameter for the purpose of optimization. In some implementations, segmentation module 404 automatically segments a relationship model 402 into any number of segments, and the segments can have varying size. For example, segmentation module 404 can segment relationship model 402 into 5 segments of equal size, or any number of segments. As another example, segmentation module 404 can segment relationship model 402 into a number of segments based on a standard distribution. More specifically, segmentation module 404 may define a first segment representing the average value, and additional segments based on standard deviations from the average value. In other implementations, segmentation module 404 can segment relationship model 402 based on predefined ranges. For example, labor hours may be segmented into pre-defined ranges such as 400-500, 500-600, and 600-700. Segmentation module 404 determines aggregate values for the operations parameter, performance metric, and confidence scores for each segment. The segments, and associated aggregated values, can be stored as rows in a table. The output of segmentation module 404 is illustrated in, at least, FIG. 6B.

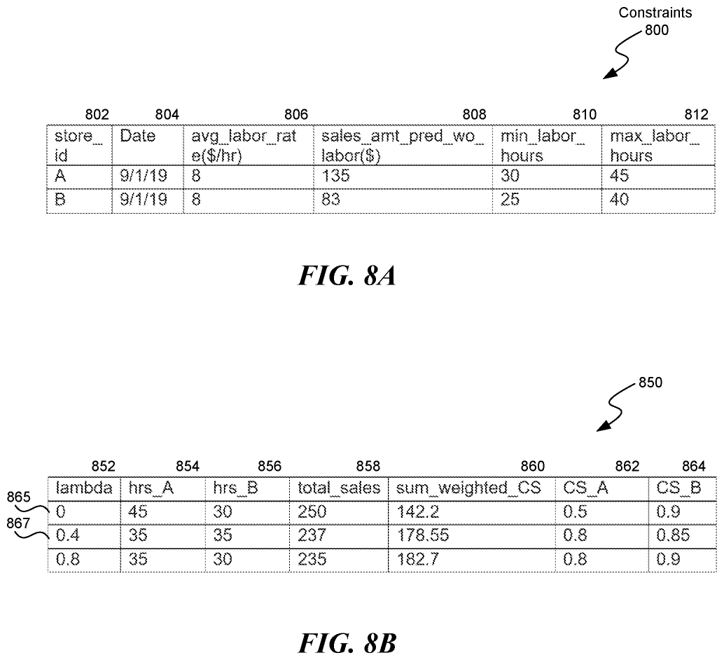

Optimization engine 210 analyzes tabular data 406 in view of additional stored optimization rules, parameters, and constraints. The operation of optimization engine 210 is further described in relation to FIGS. 5, 8A, and 8B. Overall, optimization engine 210 attempts to optimize (e.g., minimize, maximize, etc.) a set of performance metrics by adjusting operations parameters, while at the same time observing dynamic constraints on the operations parameters (e.g., the cost of labor, maximum working hours). Optimization engine then outputs optimized resource allocations 410. Optimized resource allocation 410 includes a particular selected value of the operations parameter. For example, optimization engine 210 can determine 197 labor hours is the optimal amount of a retail store, or $122,000 is the optimal monthly advertising spend for the retail store.

FIG. 5 is a data flow diagram illustrating operation of the optimization system of FIG. 1. Optimization engine 210 determines optimized resource allocation 504 for performance relationship model 402. Optimization engine 210 implements objective function 508, operations constraints 503, and risk parameter 506 to determine optimized resource allocation 504. In some implementations, optimization engine 210 further considers general performance forecast 502. Overall, objective function 508 minimizes or maximizes a selected performance metric. Objective function 508 defines both optimizing performance and risk evaluation on the optimized resource allocation based on confidence scores.

In the example implementation, risk parameter 506 is user-configurable, and users can define a relative level of risk tolerance. In other implementations, optimization engine 210 generates multiple instances of optimized resource allocation 504 for a variety of pre-set and/or automatically determined values of risk parameter 506. In other words, optimization engine 210 may generate different optimized resource allocations for different levels of risk parameter 506.

Optimization engine 210 optimizes (e.g., minimizes, maximizes) the performance metric 510, while considering constraints on the associated operations parameter. In one implementation, operations constraint 503 includes min/max values for operations parameter 508. For example, the maximum labor hours in a month can be 200 hours for all employees working at a location.

In some implementations, operations constraints 503 includes dynamic constraints. Dynamic constraints define an additional relationship between the operations parameter and the performance metric, and can include a cost per labor hour, cost of advertising spending, cost (e.g., utilities) of increased operating hours, and so on. Optimization engine 210 computes the impact of the dynamic constraint when analyzing the operations parameter. In one implementation, operations constraints 503 includes an average cost per labor hour. Thus, optimization engine 210 is configured to balance the cost of increasing labor hours against the projected gains in performance metric 510.

Risk parameter 506 can be user configurable, such that a user (e.g., an administrator, a store manager, an HR user, etc.) can define a relative risk tolerance. For example, a business organization can have a higher risk tolerance with advertising spending compared to employee staffing. In other words, it is easy to adjust advertising spend, and can be difficult to onboard/offboard employees. Optimization engine 210 accounts for this using risk parameter 506. Risk parameter 506 defines the risk tolerated by optimization engine 210. For example, relationship model 402 can indicate that raising the operations parameter 508 also raises performance metric 510, but with a low confidence score. In this example, a high value of risk parameter 506 results in the optimization engine 210 selecting the higher value of optimization parameter 508 as the optimized solution. However, a lower value of risk parameter 506 can result in optimization engine 210 selecting the lower (e.g., safer) value of optimization parameter 508, and forgoing the uncertain potential gains.

Optimization engine 210 also compares performance relationship model 402 to general performance forecast 502. In the example implementation, general performance forecast 502 is not a relationship model, and is instead an overall forecast of performance metric 510. In other words, general performance forecast 502 is not dependent on operations parameter 508. Optimization engine 210 utilizes general performance forecast 502 as a sanity check in determining optimized resource allocation 504. Excessive deviation from general performance forecast 502 can trigger an alert and/or selection of a higher-confidence value of operation parameter 508. For example, dramatic changes in the performance metric cannot be feasible, and/or can indicate computational errors.

### Example Tables and Data Visualizations

FIG. 6A is a chart diagram illustrating performance data, operations data, and a relationship model. Operations parameter 602 (e.g., labor hours) is related to performance metric 604 (e.g., revenue). Plot 600 includes data points retrieved from data sources, as shown in FIG. 1. Operations parameter 602 ranges from 25 to 45, and performance metric ranges from 80 to 120. In the example implementation, plot 600 includes high confidence region 616 and low confidence region 606.

Multiple relationship models are illustrated in plot 600. In the illustrated implementation, optimization system 100 is configured to aggregate/group performance and operations data based on store locations. Optimization system 100 can be configured to automatically select a relationship model, or combine/aggregate multiple relationship models.

FIG. 6B is a table diagram illustrating a tabular implementation of a relationship model, as generated by segmentation module 404 in FIG. 4.

Table 650 corresponds to plot 600 in FIG. 6A. Table 650, and the included relationship models, are segmented and stored as records in table 650. Table 650 includes values of operations parameters, performance metrics, and confidence scores.

Record 664 includes, at least, an operations parameter, performance metric, and a confidence score. Record 664 includes operations parameter 658, performance metric 660, and confidence score 662. In the example implementation, operations parameter 658 has the label “labor hours(hrs)” and performance metric “predicted sales amount (sales_amt_pred)($)”.

Operations parameter 658 corresponds to ranges of operations parameter 602, shown in plot 600. In other words, operations parameter 658 identifies ranges (e.g., segments) of plot 600. For example, record 664 includes value “30” for operations parameter 658. This value corresponds to a segment of plot 600, such as the range 25 (the minimum value) to 30 of operations parameter 602. Based on this segment, record 664 includes aggregated values for the performance metric 660 and confidence score 662. For example, record 664 includes value “120” for performance metric 660. In the example implementation, performance metric 660 is the average value of performance metric 604 for the associated segment. Performance metric 660 can be any aggregated form of performance metric 604, such as a min/max value, mode value, and so on. Column 656 sequentially identifies which segment (e.g., a ‘cut point’) a record corresponds to. For example, record 665 indicates the value in column 658 corresponds to the first segment of the relationship model.

Optimization system 100 can be configured to group operations and performance data based on any value. In the illustrated implementation, table 650 includes two sets of data, and identified by column 652. More specifically, column 652 includes store identifiers. In other implementations, other grouping identifiers may be defined, such as store identifiers, region identifiers, department identifiers, and so on. As shown in FIGS. 7A and 7B, multiple relationship models can be determined in response to the grouping defined in column 652 (e.g., store identifiers). In the illustrated implementation, table 650 further includes the date the data was generated, as defined in column 654.

FIG. 7A is a chart diagram illustrating two segmented (e.g., tabularized, aggregated) relationship models. More specifically, FIG. 7A illustrates two segmented (e.g., tabularized, aggregated) relationship models. Optimization system 100 is configured to generate relationship models 704 and 702 based on performance and operations data, as shown in FIGS. 6A and 6B. In the example implementation, optimization system 100 has grouped the data by store, to generate two unique relationship models. Relationship model 704 is associated with store A, and relationship model 702 is associated with store B. In other implementations, the relationship models can be grouped by other factors, such as store department, employee type, store region, and so on. Relationship models 702 and 704 define a predicted value of performance metric 604 for values of operations parameter 602.

FIG. 7B is a chart diagram illustrating confidence scores corresponding to the relationship models illustrated in FIG. 7A. Relationship modeling module 206 (shown in FIG. 2) is configured to generate relationship model 702, and the corresponding confidence scores 708. Relationship model 702 accepts input of a value of operations parameter 602 and returns a forecasted value of performance metric 604. In comparison, confidence scores 708 accepts input of the same operations parameter 602 and returns a confidence score, defining a confidence level in the forecasted value of the performance metric. Overall, both a confidence score and a predicted performance metric value can be determined for a specific value of the operations parameter 602. Relationship modeling module 206 can determine confidence scores associated with relationship models 702 and 704 using statistical and/or machine learning techniques, such as subsampling. In the illustrated implementation, confidence scores 708 is associated with relationship model 704 and store B. Confidence scores 706 is associated with store A and relationship model 702.

Confidence scores 708 corresponds to relationship model 702. In the illustrated implementation, confidence score 710 is a decimal scale from 0-1. In other implementations, confidence score can be a probability, inverse probability, numerical score (e.g., 1-100, 1-1000), and so on.

FIG. 8A is a table diagram illustrating operations constraints utilized by the optimization system of FIG. 1. Operations constrains can include simple and dynamic constraints. Simple constraints include restrictions on operations parameters and/or performance metrics. For example, columns 810 and 812 define minimum and maximum values for labor hours (e.g., an operations parameter). Columns 810 and 812 have the labels minimum labor hours (“min_labor_hours”) and maximum labor hours (“max_labor_hours”) respectively. Dynamic constraints include additional calculated factors to include in the optimization analysis. Dynamic constraints define an additional relationship between the operations parameter and the performance metric. In the example implementation, the operations constraints include a dynamic constraint of an average cost per labor hour (“avg_labor_rate($/hr)”), as defined in column 806. Thus, optimization engine 210 is configured to balance the cost of increasing labor hours against the projected gains in performance metric. For example, column 806 enables optimization engine 210 to compare the benefit of increased sales to the increased associated labor costs. In other words, optimization engine 210 can determine increasing staffing increases sales, but the corresponding increase in labor costs (calculated based on column 806) can impact the increased sales.

Constraints 800 optionally includes a general performance forecast. Column 808 defines a general (e.g., naive, overall) forecasted value of the performance metric, independent of any particular changes in the operations parameter. Thus, column 808 may be used as a ‘sanity check’ to evaluate the feasibility of optimized values of the performance metric. Column 808 may also be used as a weighting factor for confidence scores. More specifically, column 808 may be used to promote (e.g., change in scale) confidence scores from a range of 0.0 to 1.0, to the same magnitude as a predicted sales value. Confidence scores and weighted confidence scores are further described in relation to columns 860 and 862 in FIG. 8B. In the illustrated implementation, column 808 includes a sales amount prediction without labor (“sales_amt_pred_wo_labor($).” General performance forecasts, such as column 808, is further described in relation to block 502 in FIG. 5.

In some implementations, the operations constraints may differ by organizational groups, such as store locations, departments, regions, and so on. In the illustrated implementation, column 802 defines a store identifier corresponding to column 652 in FIG. 6B and. Thus, operations constraints may be customized for individual locations/units. FIG. 8B also includes optimized resource allocations corresponding to the identifiers defined in column 802. For example, a value of the operations parameter may be selected for each store identifier. Constraints 800 optionally includes column 804, indicating a date when the constraints were received. In other implementations, column 804 may define a time period for which the constraints are active. For example, column 804 may be compared to column 654 (shown in FIG. 6B) to match constraints to the appropriate relationship model.

FIG. 8B is a table diagram illustrating optimized resource allocations generated by the optimization system of FIG. 1. Overall, optimization engine 210 analyzes relationship models (shown in FIG. 7A) in view of confidence scores (shown in FIG. 7B) and constraints (shown in FIG. 8A). Then, optimization engine 210 generates optimized resource allocations 850. Different optimized values of the operations parameter are provided based on a user-selected risk parameter. In the illustrated implementation, column 852 stores user-selected values of the risk parameter, labeled as lambda values.

The lambda values denote a relative level of risk tolerated in the optimized resource allocations. For example, a business may be more tolerant to risk in determining an amount of money to spend on advertising, compared to a low tolerance for risk in employment decisions. For example, a business may expect a high level of confidence before deciding to hire additional employees. In contrast, a business may be more inclined to take risks on advertising spending, based on a subjective analysis of an advertising campaign. In some implementations, optimization engine 210 receives lambda values from users. In other implementations, optimization engine 210 stores pre-defined lambda values corresponding to categories of optimization parameters, and is configured to select the appropriate stored lambda value. In yet other implementations, optimization engine 210 determines the lambda value dynamically. More specifically, the lambda value can be determined by a heuristic search to provide scenario analysis for different risk level requirements.

The user-selected risk parameter is used to specify how the optimization engine 210 performs resource allocation in view of the confidence scores. For example, FIG. 7B illustrates confidence scores, which have differing values across a range of operating data values. Lambda values define how optimization engine 210 interacts with lower confidence regions. By way of example, record 867 in FIG. 8B includes a moderate lambda value (0.4) in column 852, and thus optimization engine generates a more conservative resource allocation, as defined in column 854 and 856. Record 865 includes a low lambda value in column 852, and thus optimization engine 210 determines a more aggressive (e.g., risk tolerant) resource allocation. More specifically, record 865 includes high levels of staffing (e.g., labor hours defined in columns 854 and 856) and a corresponding high amount of total sales (total_sales) in column 858, compared to the corresponding values in record 867.

In the example implementation, the performance and operations data includes data from two store locations (store A and store B), as shown in FIG. 6A. Optimization engine 210 is configured to generate optimized resource allocations for each of the stores. Optimization engine 210 is configured to group performance data and operations data by any entity, such as retail store locations, brands, retail regions, countries, retail departments, and so on. The example data illustrated in FIG. 6A is grouped based on store. As another example, relationship models and optimized resource allocations can be grouped based on retail department (e.g., children, adults, home, garden). In alternate implements, optimization engine 210 can aggregate/combine the resource allocations for each entity.

Column 854 includes optimized resource allocations for store A, for the corresponding values of the risk parameter in column 852. More specifically, column 854 includes calculated values of the operations parameter determined to optimize the associated performance metric given the risk parameter. Optimization engine 210 selects the value of column 854 based on the relationship models illustrated in FIG. 7A, the confidence scores illustrated in FIG. 7B, and the constraints illustrated in FIG. 8A. For example, in row 865, the risk parameter value of 0 indicates that the values in columns 854 and 856 should be the operations parameter that achieves the highest value of the performance parameter (within the defined constraints), regardless of the confidence score associated with each value. For the higher lambda value of 0.4, shown in row 867, the optimization engine 210 selects the operations parameter values for columns 854 and 856 as being the values that both satisfy the constraints and map to the highest performance parameter value where the corresponding confidence score is greater than a specified threshold (e.g., 0.75). In other words, the optimized solutions of column 852 maximize the performance metrics according to the relationship model, but while staying within the constraints of the operations parameter. The confidence score threshold applied by the optimization engine 210 can increase as the value of the risk parameter increases, such that values of the performance parameter that are associated with higher confidence scores are selected when the lambda value is closer to 1.0. As the lambda value approaches zero, the optimization engine 210 applies progressively lower confidence score thresholds, such that the selection of the operations parameter value becomes agnostic to the confidence score associated with the resulting performance parameter value.

Organizations can make resource allocation (e.g., stocking, staffing) decisions based on column 854. For example, an organization that uses a lambda value of 0 (indicating high risk tolerance) can determine that 45 labor hours is optimal at store A and 30 staff hours is optimal at store B.

In the illustrated example, optimized resource allocations 850 defines an optimal resource allocation that includes a unique number of labor hours for multiple locations of a retail store (e.g., Store A in column 854, Store B in column 856). Column 854 has the label “hrs_A” indicating the operations parameter and the associated location. Column 856 has the similar label “hrs_B”. In other implementations, optimized resource allocations can include an overall value. As shown in FIG. 6B, the performance and operations data included column 652 defines a store identifier (“store_id”, e.g., A, B). Optimization engine 210 is configurable to group performance and operations data based on identifiers/columns. Further, optimization engine 210 can generate an optimized value of the operations parameter for each organizational unit/group (e.g., retail store locations, departments, regional divisions, etc.). Optimization engine 210 is configured to generate optimized resource allocations including any number of individual values of the operations parameter (e.g., any number of locations, a single location, a single overall value).

Optimized resource allocations 850 further includes confidence scores for the optimized resource allocation as a whole, and any individual components of the optimized resource allocation (e.g., columns 854 and 856). Columns 862 and 864 include the individual confidence scores (CS) for each store (store A and store B respectively), as indicated by the labels “CS_A” and “CS_B”. The individual confidence stores for optimized resource allocations 850 are determined using the confidence scores associated with the underlying relationship models.

Column 860 defines an overall (e.g., weighted sum) of the individual confidence scores (“sum_weighted_CS”). In the example implementation, column 860 is calculated by combining the individual confidence scores (e.g., 862, 864) with the corresponding general sales amount prediction (column 808 in FIG. 8A), and summing up the promoted confidence scores. For example, the values of column 862 (confidence scores for store A) can be multiplied with the general sales predication for store A, illustrated in the first row column 808 (shown in FIG. 8A). More specifically, column 860 can be determined by multiplying each value in column 808 (general sales amount prediction, for each of stores A and B) with confidence score 862 and 864 individually (i.e., multiplying the sales prediction of store A by the store A confidence score 862, and multiplying the sales prediction of store B by the store B confidence score 864) to promote confidence score to the same number magnitude as total_sales 858. The weighted confidence score value shown in column 860 is then generated by calculating a sum of the weighted sales predictions calculated for store A and store B.

In some implementations, the total sales in column 858 and weighted confidence scores in column 860 are combined in an optimization analysis. For example, the optimization engine 210 calculates an optimization objective by adding the total sales in column 858 to the product of the lambda value (column 852) and the weighted confidence score (column 860). In this case, the lambda value functions as a weight between the predicted total sales with laborers and the weighted confidence score.

In other words, the values of columns 854 and 856 are compared to the plot shown in FIG. 7B to determine the appropriate confidence score for the selected value of the operations parameter. Optimized resource allocations 850 further includes the projected value of the performance metric for the optimized solution. Column 858 defines a total sales number (“total_sales”) for each of the optimized resource allocations. For example, column 858 includes total forecasted sales for both store A and store B.

### Optimization Engine Process

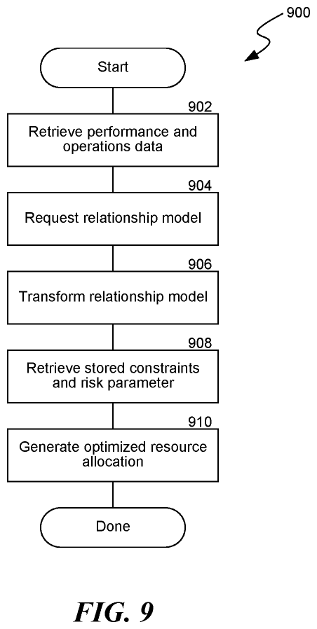

FIG. 9 is a process diagram illustrating a method for generating optimized resource allocations. At block 902, process 900 retrieves performance and operations data. Performance data includes sales data retrieved from a retail point-of-sale system. Operations data includes employee labor hours retrieved from a staffing computer system and/or database. Process 900 is configurable to optimize any combination of performance and operations data. For example, process 900 can optimize advertising dollars spent (e.g., operations data, an operations parameter) to maximize foot traffic and/or unique website visitors (e.g., performance data, a performance metric). Process 900 is also configurable to retrieve performance and operations data from any electronic business data source, such as databases, resource planning systems, and so on. For example, process 900 can implement an internet-based application programming interface (web API), or an open database connectivity (OBDC) protocol.

At block 904, process 900 requests a relationship model. The relationship model can be visualized as a curve relating an operations parameter to a performance metric. The relationship model forecasts projected levels of the performance metric for a range of values of the operations parameter. Process 900 selects an operations parameter (e.g., an independent variable) from the operations data. For example, process 900 can select employee labor hours as the performance parameter, based on operations data including time/attendance data, timesheet data, staffing schedule data, etc. As another example, process 900 can select an operation parameter of advertising dollars spent from an invoice database including advertising invoices (e.g., operations data). Process 900 further selects at least one performance metric from the performance data. For example, process 900 select a performance metric of total sales from a transaction database (e.g., performance data), and/or a business intelligence system. In one implementation, process 900 communicates with a cloud-based relationship modeling system and/or a 3rd-party software library for relationship modeling. In other implementations, process 900 locally generates a relationship model.

At block 906, process 900 transforms the relationship model into tabular data for processing by the optimization engine. The relationship model generated at block 904 can be continuous (e.g., a curve), and process 900 aggregates the relationship model into segments. For example, process 900 can define intervals of the operations parameter, and further aggregate the forecasted performance metric for each of the intervals. Thus, each interval and the associated aggregated performance metric can be stored as a record in a table, facilitating analysis by the optimization engine at block 910 (described below).

At block 908, process 900 retrieves stored constraints and a risk parameter. Stored constraints include constraints on the operations parameter and/or performance metric, such as minimum/maximum values. In some implementations, stored constraints include dynamic constraints that define an additional relationship between the performance metric and the operations parameter. For example, stored constraints can include a cost per labor hour, which impacts optimizations directed to net profit.

At block 910, process 900 generates an optimized resource allocation. Process 900 analyzes the transformed (e.g., segmented, discretized, tabularized) relationship model generated at block 906, and the constraints retrieved at block 908. Process 900 then determines an optimized resource allocation (e.g., a value of the operations parameter) that optimizes (e.g., minimizes, maximizes) the performance metric while considering the constraints (e.g., cost of labor, maximum/minimum values). The generation of optimized resource allocations is further described in relation to FIG. 5, and is illustrated in FIGS. 6-8.

Process 900 can further include transmitting the optimized resource allocation to a computing device and/or providing a user interface (e.g., client application) for viewing the optimized resource allocation. In one implementation, process 900 includes generating an interactive webpage including a chart visualizing both the relationship model obtained at block 904 and the optimized resource allocation generated at block 910.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number can also include the plural or singular number respectively. The word “or,” in reference to a list of two or more items, covers all of the following interpretations of the word: any of the items in the list, all of the items in the list, or any combination of the items in the list.

The above detailed description of implementations of the system is not intended to be exhaustive or to limit the system to the precise form disclosed above. While specific implementations of, and examples for, the system are described above for illustrative purposes, various equivalent modifications are possible within the scope of the system, as those skilled in the relevant art will recognize. For example, some network elements are described herein as performing certain functions. Those functions could be performed by other elements in the same or differing networks, which could reduce the number of network elements. Alternatively, or additionally, network elements performing those functions could be replaced by two or more elements to perform portions of those functions. In addition, while processes, message/data flows, or blocks are presented in a given order, alternative implementations can perform routines having blocks, or employ systems having blocks, in a different order, and some processes or blocks can be deleted, moved, added, subdivided, combined, and/or modified to provide alternative or subcombinations. Each of these processes, message/data flows, or blocks can be implemented in a variety of different ways. Also, while processes or blocks are at times shown as being performed in series, these processes or blocks can instead be performed in parallel, or can be performed at different times. Further, any specific numbers noted herein are only examples: alternative implementations can employ differing values or ranges.

The teachings of the methods and system provided herein can be applied to other systems, not necessarily the system described above. The elements, blocks and acts of the various implementations described above can be combined to provide further implementations.

Any patents and applications and other references noted above, including any that can be listed in accompanying filing papers, are incorporated herein by reference. Aspects of the technology can be modified, if necessary, to employ the systems, functions, and concepts of the various references described above to provide yet further implementations of the technology.

These and other changes can be made to the invention in light of the above Detailed Description. While the above description describes certain implementations of the technology, and describes the best mode contemplated, no matter how detailed the above appears in text, the invention can be practiced in many ways. Details of the system can vary considerably in its implementation details, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the invention to the specific implementations disclosed in the specification, unless the above Detailed Description section explicitly defines such terms. Accordingly, the actual scope of the invention encompasses not only the disclosed implementations, but also all equivalent ways of practicing or implementing the invention under the claims.

While certain aspects of the technology are presented below in certain claim forms, the inventors contemplate the various aspects of the technology in any number of claim forms. For example, while only one aspect of the invention is recited as implemented in a computer-readable medium, other aspects can likewise be implemented in a computer-readable medium. Accordingly, the inventors reserve the right to add additional claims after filing the application to pursue such additional claim forms for other aspects of the technology.

We claim:

1. A method comprising:
retrieving, by a computer system, a relationship model that defines a statistical relationship between operations data and performance data and that includes confidence scores indicating degrees of confidence in the statistical relationship, the operations data representing a plurality of values of an operations parameter collected over a period of time from a retail store and the performance data representing a value of a performance parameter measured for each of the plurality of values of the operations data;
extracting, by the computer system, tabular data from the relationship model, wherein tabular data points in the tabular data represent a value of the performance parameter and a confidence score that are each sampled from the relationship model for each of a plurality of segments of the operations data;
analyzing the tabular data, by the computer system, to select an operations value of the operations data to achieve an optimal value of the performance data, the selected operations value being selected from a set of values of the operations data for which the corresponding confidence score exceeds a confidence score threshold, and the optimal value of the performance data representing an optimum of the values of the performance data that are mapped, by the relationship model, to the set of values of the operations data; and
storing, by the computer system, the selected operations value.

2. The method of claim 1, wherein the set of values of the operations data comprises values of operations data that satisfy a constraint.

3. The method of claim 2, wherein the constraint comprises a minimum operations data value or a maximum operations data value.

4. The method of claim 2, wherein the constraint comprises a dynamic constraint applied to the values of the performance data mapped to the set of values of the operations data.

5. The method of claim 1, further comprising:
receiving a user-selected risk parameter indicating an amount of acceptable resource allocation risk; and
selecting, by the computer system, the confidence score threshold based on the user-selected risk parameter.

6. The method of claim 1, wherein extracting the tabular data from the relationship model comprises:
segmenting the operations data into the plurality of segments, each segment representing a range of values of the operations data;
for each of the plurality of segments, identifying a value of the performance parameter that is mapped, by the relationship model, to a value of the operations data within the respective segment.

7. The method of claim 6, wherein identifying the value of the performance parameter comprises selecting one of:
a maximum value of the performance parameter that is mapped to the respective segment;
a minimum value of the performance parameter that is mapped to the respective segment;
a median value of a range of values of the performance parameter that are mapped to the respective segment; or
a mean value of the range of values of the performance parameter that are mapped to the respective segment.

8. The method of claim 6, wherein extracting the tabular data from the relationship model further comprises determining the confidence score for each of the plurality of segments of the operations data.

9. The method of claim 8, wherein determining the confidence score for each of the plurality of segments of the operations data comprises, for a segment in the plurality of segments:
generating multiple subsamples of the performance data that was measured for values of the operations data within the segment;
calculating an intermediate model for each of the multiple subsamples that defines a relationship between the performance data in the respective subsample and the values of the operations data within the segment; and
comparing the intermediate models calculated for each of the multiple subsamples to determine the confidence score for the segment.

10. The method of claim 9, wherein comparing the intermediate models calculated for each of the multiple subsamples comprises determining at least one of:
a ratio between values of two or more of the intermediate models; or
a ratio between slopes of two or more of the intermediate models.

11. The method of claim 1, wherein the relationship model comprises a first relationship model associated with a first retail store and a second relationship model associated with a second retail store, each of the first and second relationship models defining a statistical relationship between operations data and performance data measured in the respective retail store, wherein the first and second retail stores share a pool of available resources, and wherein selects the operations value of the operations data to achieve the optimal value of the performance data comprises:
applying a constraint associated with the pool of available resources to the performance measurements to allocate the pool of available resources between the first retail store and the second retail store, the allocation selected to satisfy the constraint and achieve a collective performance target for the first retail store and the second retail store.

12. The method of claim 11, wherein the pool of available resources includes a number of employees available to work at the first retail store and the second retail store, or a total labor hours budget for the first retail store and the second retail store.

13. The method of claim 1, wherein the operations parameter includes employee timesheet data, employee schedule data, mobile device location data, employee assignment data, or retail store operating hours.

14. The method of claim 1, wherein the performance data includes payment transaction data, revenue data, profit data, interaction conversion data, transaction volume data, transaction amount data, or physical traffic data.

15. The method of claim 1, further comprising generating a webpage including an interactive chart visualization, the interactive chart visualization including the selected operations value and a visual representation of the relationship model.

16. A non-transitory computer readable storage medium storing executable computer program instructions, the computer program instructions when executed by a processor causing the processor to:
retrieve a first relationship model associated with a first retail store and a second relationship model associated with a second retail store, each of the first and second relationship models defining a statistical relationship between operations data and performance data measured in the respective retail store, wherein the first retail store and second retail store share a pool of available resources;
analyze for each of the first relationship model and second relationship model, a performance measurement derived from the corresponding relationship model for each of a plurality of intervals of the operations data;
applying a constraint associated with the pool of available resources to the performance measurements to allocate the pool of available resources between the first retail store and the second retail store, the allocation selected to satisfy the constraint and achieve a collective performance target for the first retail store and the second retail store; and
storing the selected allocation;

17. The non-transitory computer readable storage medium of claim 16, wherein the first and second relationship models each further include confidence scores indicating degrees of confidence in the statistical relationship defined by each model, and wherein applying the constraint to the performance measurements comprises:
identifying a set of operations data values that satisfy the constraint and for which the corresponding confidence score exceeds a confidence score threshold; and
selecting, from the set of operations data values, an operations data value for each of the first retail store and the second retail store to achieve an optimal value of the performance data that is mapped to the set of operations data values by a respective one of the first relationship model or the second relationship model.

18. The non-transitory computer readable storage medium of claim 16, wherein the pool of available resources includes a number of employees available to work at the first retail store and the second retail store, or a total labor hours budget for the first retail store and the second retail store.

19. The non-transitory computer readable storage medium of claim 16, wherein the constraint comprises:
a minimum operations data value or a maximum operations data value; or
a dynamic constraint applied to the values of the performance data.

20. A system, comprising:
a processor; and
a non-transitory computer readable storage medium storing executable computer program instructions, the computer program instructions when executed by the processor causing the processor to:
access a relationship model that defines a statistical relationship between operations data values and performance data values measured in a retail store and that includes a confidence score indicating a degree of confidence in the statistical relationship between the operations data values and the performance data values for each of a plurality of the operations data values;
using the relationship model, select an operations value of the operations data values to achieve an optimal value of the performance data values, the selected operations value being selected from a set of operations data values for which the corresponding confidence score exceeds a specified threshold, and the optimal value of the performance data representing an optimum of the performance data values that are mapped, by the relationship model, to the operations data values in the set; and
implement the selected value of the operations data in the retail store.
